(19) United States
(12) Patent Application Publication
(10) Pub. No.: US 2007/0014642 A1
(43) Pub. Date: Jan. 18, 2007

(54) Automatic seeds or pellets feeder

(76) Inventors: Cristian Teodorescu, Irving, TX (US); Hadi M. Hayek, Euless, TX (US)

Correspondence Address: HADI M. HAYEK, 203 MADISSON DR, EULESS, TX, 76039, US

(21) Appl. No.: 11/049,133

(22) Filed: Feb. 2, 2005

(51) Int. Cl. B65G 53/24

(52) U.S. Cl. 406/141

(57) ABSTRACT

The automatic Pet feeder caters for animals of all sizes that feed off of pallets and seeds. It can be used in any environment (interior or exterior). The timer is used to accurately feed the animals or pets at the appropriate time of the day, week or month depending on the animals' diet. It uses a blower to disburse the right amount of food. For larger feeding (farms), the automatic pet feeder can be daisy chained with other automatic pet feeders to supply larger quantities of food. It is mainly made out of plastic and is very affordable. This invention can be used in fish farms, chicken farms, aquarium, pawns, house pets etc.

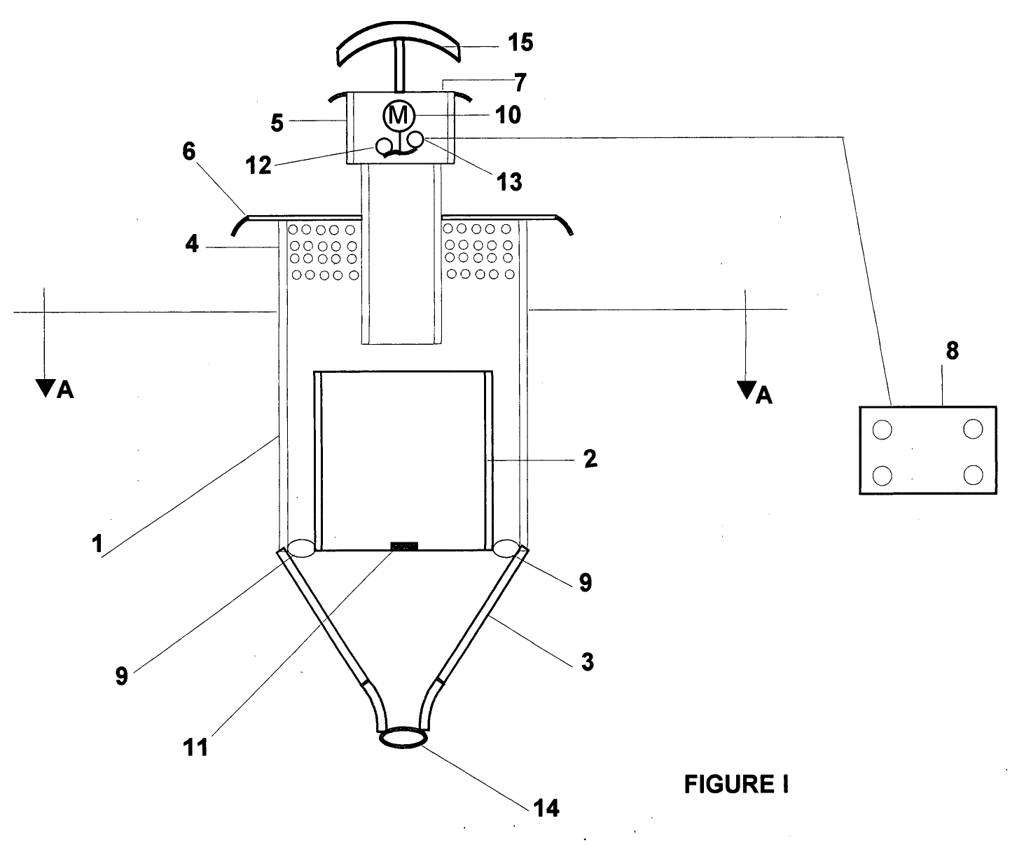

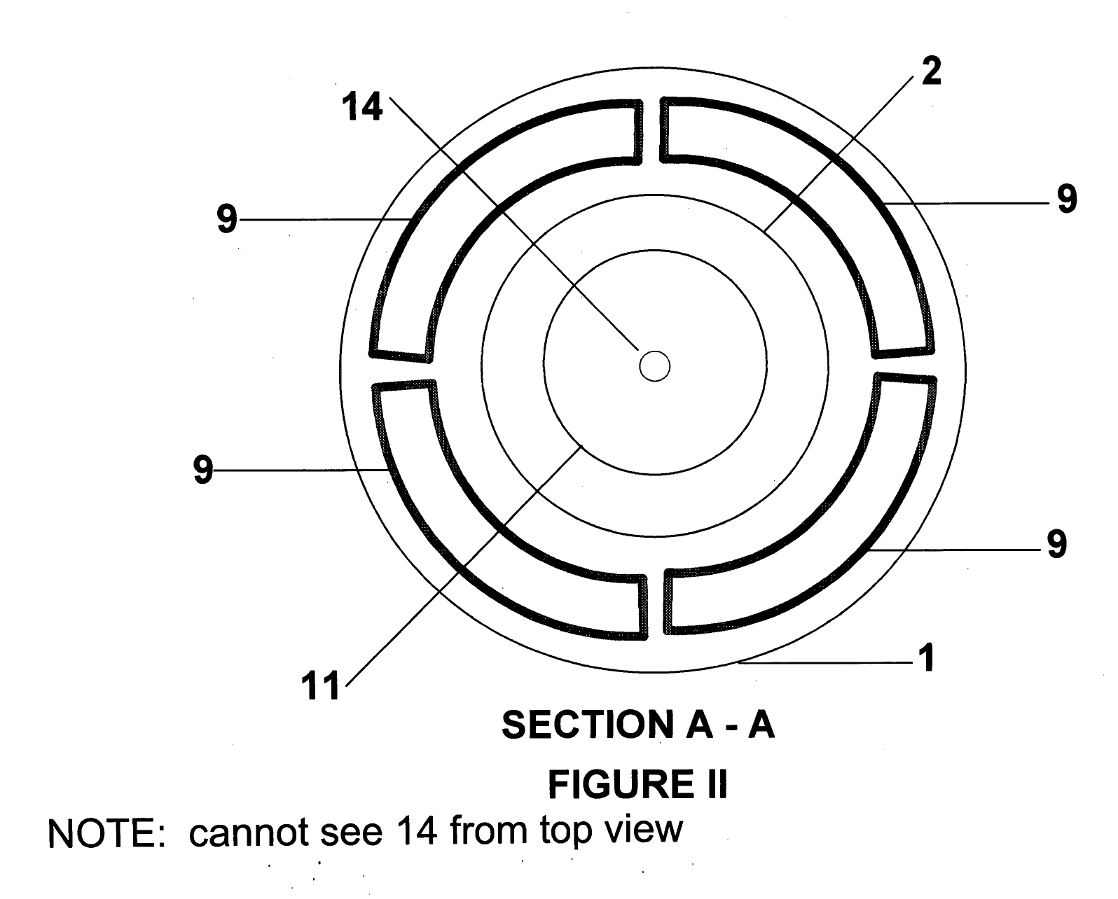

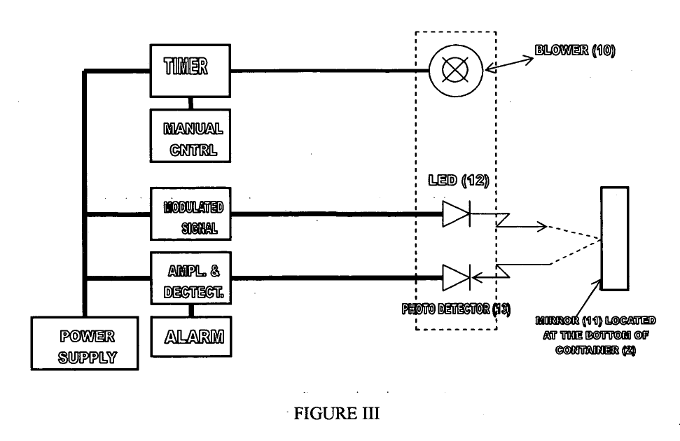

### SCOPE

The scope of this invention is to provide a universal automatic feeder for animals that need food in form of seeds or pallets, which is suitable for a large variety of applications such as in door or outdoor, different sizes of seeds or pallets, different amounts of servings, and a large period of time between refilling.

### MARKET

This type of device can be used for feeding fish in small or large ponds; can be adapted for feeding birds, for farms such as chicken, or feeding other kind of animals.

### INVENTION DESCRIPTION

Figure I describe the patent basic idea. There is an external container (1) which incorporates an internal container (2). The internal container holds the pallets' seeds. The container's bottom (1) has a large opening as it is represented in Figure II. At the bottom of the container (1) is located a funnel (3) which collects the pallets and guides them trough the opening exit. One can image different types of pipes which can transport the pallets to the required location just by the force of gravity. However, the blower's air helps the pallets' proper evacuation. The external container is covered with a lid (6) which is intended to protect the contents of the container (2) against the weather conditions such as rain or other animals such as birds. There are a number of holes (4) at the top of the container (1) which are imperative in the functionality of this device. They are necessities to the system's aero dynamicity which allows the pallets to jump from the container (2) during the blower's activation (5). Blower (5) is consisted of an electric motor (10), a cylindrical box (5) and a lid (7) which is intended to protect the motor and the pallets against the weather such as rain. Holes are present at the top of the box (5) to allow for the air intake. The blower (5) is controlled by the control unit (8). An example of the implementation of the unit is represented in Figure III.

The central block is a programmable timer similar to the ones used in applications such as water systems (sprinkler systems). This feature will allow the customer to program the date, the hour and the time (usually in seconds) to keep the blower active for feedings. This time is proportional with the amount of pallets per serving.

One can introduce a correction or this time for particular pallets which may require more time for the blower when the container (2) is close to be empty.

A manual control can supersede the automatic control, so the operator can check the functionality of the feeder or can take over manually the feeding operation.

One can imagine different implementations of this control unit (8) which can control more than one feeder. The idea is to have control unit (8) monitoring many feeders daisy chained together. This is designed to feed a large quantity of animals such as chicken or fish in a farm environment.

### FUNCTIONALITY

The blower (5) is attached to the lid (6). By lifting the blower (5), one can fill the internal container (2) with pallets or seeds, and then the blower (5) and lid (6) are placed back at the top of the container (1).

The control unit (8) is plugged into an external outlet and then is programmed to activate the blower (5) at the desired date and time. There are a limited number of servings depending on the size selection of the container (2) and the desired amount per serving. The timer can provide one or more servings per day. For each particular implementation and application, there are a corresponding number of servings. The operator can learn how to find out about the number and then visit the feeder and refill it. However, there is an additional (optional) feature of this invention which allows to automatically detect when the container (2) is empty and to trigger an alarm. There is a mirror (11) installed at the bottom of the container (2). Below the blower's propeller, there are one laser light source (LED) and a photo detector. When the container (2) is empty, the blower blows the dust off the mirror which in turns enable the modulated light to be reflected back to its main source. The modulated light will be relatively easy to extract from the surrounding noise. After the container (2) is filled with pallet and the timer has been programmed and turned ON, when the feeding time comes, the control unit (8) powers the blower with a low voltage (a particular implementation will be 24 volts VDC) for a period of time (usually in seconds) during which the blower propels the pallets out of container (2) into container (1) where they gather into the funnel (3) and then directed to the opening exit (14) for disbursement. The air flow helps the pallets exit but they will fall into the opening exit due to mainly gravity.

There is one button located on the timer which allows the operator to activate the blower to switch from automatic to manual feeding.

### COMPARISON WITH OTHER PRODUCTS

The authors are aware of a small size feeder which is intended for aquariums. It uses a mechanism which grabs a quantity of pallets with a cup activated by an electrical motor with gears, and discards the content in the opening. This particular device is not suitable for outdoor applications and for large quantities of pallets. There is also large size feeders which are used for dears, chickens, basically any animal that requires being fed with pallets. Their operation is to disburse large size of feed to the different animals listed above. These feeders are bulky, heavy, made out of metal and are very expensive. They also cannot be controlled by one unit. Any application which will try to utilize this principle for larger sizes (i.e. ponds) will become prohibitive in term of price and will not be a reliable device.

### IMPROVING FEATURE OF THE PRESENT INVENTION

Improving Feature of the Present Invention

This invention has the following advantages:
The feeder itself is very simple and does not require complicated gear. It can be implemented in a large variety of sizes without practically affective the price.
Blowing air on the pallets helps to separate them due to atmospheric conditions such as humidity.
It can be used for a large variety or pallets and seeds, hence the possibility to be utilized for feeding different kind of animals, especially for farming applications.
It has a simple mechanism to detect when the container is empty.
Due to the simplicity of this design, the price is very inexpensive and affordable.
It is a very reliable and robust device, easy to install, maintain and operate.

1) Invention as represented in Figure I which consists of two containers, one external (1) and the other one internal (2) that is filled with pallets; a blower (5) which blows the air on the top of the container (2), air which makes the pallets jump out of container (2), due to the holes (4) located at the top of container (1), into container (1); pallets that will fall between the two containers (1) and (2) through the openings located on the bottom (as illustrated in Figure II) of the container (1) and then collected through the funnel (3) and directed out from the opening exit (14).

2) Invention as represented in Figure III which is using an automatic timer to turn ON and OFF the feeder; timer which has an automatic correction of the activated time for the blower (5) correlated with the number of servings provided.

3) Invention as represented in Figures I and III which detects and alarms when the container is empty by using a modulated light source located below the propeller; a mirror located at the bottom of the container (2) and a photo detector located below the propeller.
